(19) United States
(12) Patent Application Publication
(10) Pub. No.: US 2022/0114557 A1
(43) Pub. Date: Apr. 14, 2022

(54) Establishing schedules to monitor user's behavior or activity

(71) Applicant: Ping-Chun Wang, New Taipei City (TW)

(72) Inventor: Ping-Chun Wang, New Taipei City (TW)

(21) Appl. No.: 17/067,789

(22) Filed: Oct. 12, 2020

(51) Int. Cl. G06Q 10/10; H04L 29/08; G06K 9/00; G10L 15/26; G08B 21/24

(52) U.S. Cl. CPC G06Q 10/1093; H04L 67/22; H04L 67/125; G08B 21/24; G06K 9/00664; G10L 15/26; G06K 9/00362

(57) ABSTRACT

A establishing schedule method provides services to automatically establish schedules for monitoring a regular activity or behavior of a user. The method determines the initiation of the services by acknowledging a request of a user. The system activated by the initiation of the services automatically is configured to interact with electronic devices in the area where a user locates for periodically collecting information about their activity or behavior. It deliberately analyze the information to generate a lot of processes for establishing schedules. In response to the establishment of the schedules, the system is automatically activated to monitor user's regular activity or behavior. The method is designed to save a lot of time on the complicated schedule settings and remind users how to complete their regular activity or behavior in order to prevent from neglecting processes.

### BACKGROUND

Mostly users regularly do something or activity, they usually have to first make plans and records by using calendars, notebooks, mental ways or electronic devices. The electronic device mentioned herein is like smartphone, laptop, personal computer or other electronic devices. Some of people like to memorize plans in their minds or make notes on calendars or notebooks. However, they often forget the plans or how to do it. They also use smart devices like a smartphone, laptop, personal computer or other electronic devices to make schedules and the alarms which can remind them to do activity. Regarding establishing schedules for a regular behavior or activity, a user still has to use electronic devices making a schedule. Most of people are lazy to establish schedules by using electronic devices.

Basically, the schedule setting for one event is easy for many end users. But, many babies and elders don't know how to operate smartphones, computers and electronic devices to complete the schedule settings. Actually, an activity or behavior consists of several events which may happen consecutively. For example, an exercise may consist of many consecutive actions or events. Smartphones, computers and electronic devices all may be difficult to configure consecutive schedules and alarms. These devices only support to set a schedule for one event, end users have to set a lot of consecutive events respectively by themselves, then make connections for these individual events.

Currently, the platforms of these devices may not support that the schedule's app can configure communication sessions between these devices and peripheral electronic devices in order to interact with the peripheral electronic devices. The configuration of the communication sessions and interaction between these devices and peripheral electronic devices may be more complicated for most of end users. Only professional users may be able to complete it. So, the method may adopt various technologies, for example AI (Artificial Intelligence), IOT (Internet of Things) and big data, to recognize the purposes of end users' behavior and activity for automatically configuring their schedules. It may be able to identify the beginning behavior and activity of users to suggest favorite programs which they can choose. It may further instruct them how to complete the programs and remind them what to do. Finally, it may save a lot of time on the configuration of the consecutive schedules.

### SUMMARY

The method and system described herein provide services to automatically configure schedules for regular activity or behavior of users. They may use their electronic devices to configure schedules for regular activity or behavior. The electronic devices include smartphones, laptops, computers, servers, workstations and other smart devices. Basically, the regular activity or behavior comprises a lot of consecutive events. The method may have to configure one or more schedules for checking whether one activity or behavior is completed. So, the settings of consecutive schedules for several activities or behavior of users are more complicated.

The method may attempt to establish a communication session between servers, smart devices and peripheral devices for their interactions. It may be intended to capture a number of images or video streams through PC camera, CCTV camera (Closed-Circuit Television camera) or IP camera (Internet Protocol camera) and collect other information through peripheral devices in order to establish schedules for monitoring the activity or behavior of users. Then, it may establish the schedules by using the result of the analysis on the number of images or video streams and information. After the schedules are established, the method may activate the schedules to monitor them when it detects the beginning of user's activity and behavior. In response to the detection of user's mistakes, it may offer users reminders and alarms, and make them do something efficiently.

The present disclosure describes the following implementations, a establishing schedule method comprises requesting, by a plurality of smart clients, to set a communication session over one or more networks for all clients for establishing new schedules. The method comprises interacting with all the clients engaged in the communication session over one or more networks for configuration. The method comprises controlling all the clients engaged in the communication session over one or more networks to capture a number of images or videos, voice and information. The method comprises storing the number of the images or videos, voice and information captured by all the clients in a repository. The method comprises analyzing the number of the images or videos, voice and information captured by all the clients to generate a series of processes. The method comprises composing the series of the processes, in response to the generation of the series of the processes. The method comprises simulating the composition of the series of the processes for the new schedules. The method comprises establishing the new schedules in accordance with that the simulation for the new schedules is completed and acknowledged. The method comprises comparing the processes generated from the upcoming images or videos, voice and information captured by all the clients with those of the existing schedules in the repository, in response to the execution of the group of the existing schedules including the new ones.

The method further comprises searching for solutions for improving the processes of the existing schedules or creating new schedules, providing the plurality of the smart clients engaged in the communication session over one or more networks with suggestions for modifying the processes or creating the new schedules, and determining the modification of the existing processes or creation of the new schedules, in response to the acknowledgment of the smart clients for suggestions.

The method further comprises determining a registration for an unregistered client or thing, in response to the detection of the unregistered client or thing participating in one or more networks or the area where users locate, and activating the schedules that the unregistered client or thing involves, after reorganizing the processes that the unregistered client or thing involves and refreshing the configuration.

The method further comprises detecting a registered client engaged in the communication session over one or more networks or thing leaving the communication session or the area where users locate, activating alarms through the at least one client of the plurality of the clients engaged in the communication session over one or more networks, and terminating the schedules that the registered client or thing involves.

The method further comprises determining a configuration of a registered client or thing, in response to the detection of the registered client or thing participating in one or more networks or the area where users locate, and activating the schedules that the registered client or thing involves after reorganizing the processes of the schedules that the registered client or thing involves and refreshing the configuration.

The method further comprises monitoring the number of images or videos, voice and information captured by all the clients engaged in the communication session over one or more networks, and activating alarms through the at least one client of the plurality of the clients engaged in the communication session over one or more networks, in response to the detection for a divergence of users' behavior from the processes of the schedules.

The non-transitory computer-readable medium storing instructions that, when executed by a processor, cause the processor to implement the method comprises requesting, by a plurality of smart clients, to set a communication session over one or more networks for all clients for establishing new schedules. The method comprises interacting with all the clients engaged in the communication session over one or more networks for configuration. The method comprises controlling all the clients engaged in the communication session over one or more networks to capture a number of images or videos, voice and information. The method comprises storing the number of the images or videos, voice and information captured by all the clients in a repository. The method comprises analyzing the number of the images or videos, voice and information captured by all the clients to generate a series of processes. The method comprises composing the series of the processes, in response to the generation of the series of the processes. The method comprises simulating the composition of the series of the processes for the new schedules. The method comprises establishing the new schedules in accordance with that the simulation for the new schedules is completed and acknowledged. The method comprises comparing the processes generated from the upcoming images or videos, voice and information captured by all the clients with those of the existing schedules in the repository, in response to the execution of the group of the existing schedules including the new ones.

The system comprises one or more processors, and one or more non-transitory computer-readable media storing instructions that, when executed by the one or more processors, cause the system to perform operations comprises requesting, by a plurality of smart clients, to set a communication session over one or more networks for all clients for establishing new schedules. The method comprises interacting with all the clients engaged in the communication session over one or more networks for configuration. The method comprises controlling all the clients engaged in the communication session over one or more networks to capture a number of images or videos, voice and information. The method comprises storing the number of the images or videos, voice and information captured by all the clients in a repository. The method comprises analyzing the number of the images or videos, voice and information captured by all the clients to generate a series of processes. The method comprises composing the series of the processes, in response to the generation of the series of the processes. The method comprises simulating the composition of the series of the processes for the new schedules. The method comprises establishing the new schedules in accordance with that the simulation for the new schedules is completed and acknowledged. The method comprises comparing the processes generated from the upcoming images or videos, voice and information captured by all the clients with those of the existing schedules in the repository, in response to the execution of the group of the existing schedules including the new ones.

### DESCRIPTION OF THE DRAWINGS

FIG. 1 is a viewpoint of cameras capturing images or videos of people.

FIG. 2 is a block diagram of a system that may be used to implement the methods and systems described in the document.

FIG. 3 is a block diagram illustrating the AI module of the server.

FIG. 4 is a block diagram illustrating the big data module of the server.

FIG. 5 is a block diagram illustrating the IOT module of the server.

FIG. 6 is a block diagram illustrating the image processing module of the server.

FIG. 7 is a flowchart of a process for schedules settings method.

FIG. 8 is a block diagram illustrating components of a computing device that may be used to implement the methods and systems described in the document, as a client, server or plurality of servers.

FIG. 9 is a block diagram illustrating components of a computing device that may be used to implement the methods and systems described in the document, as a client or plurality of clients.

Like reference symbols in the various drawings indicate like elements.

### DETAILED DESCRIPTION

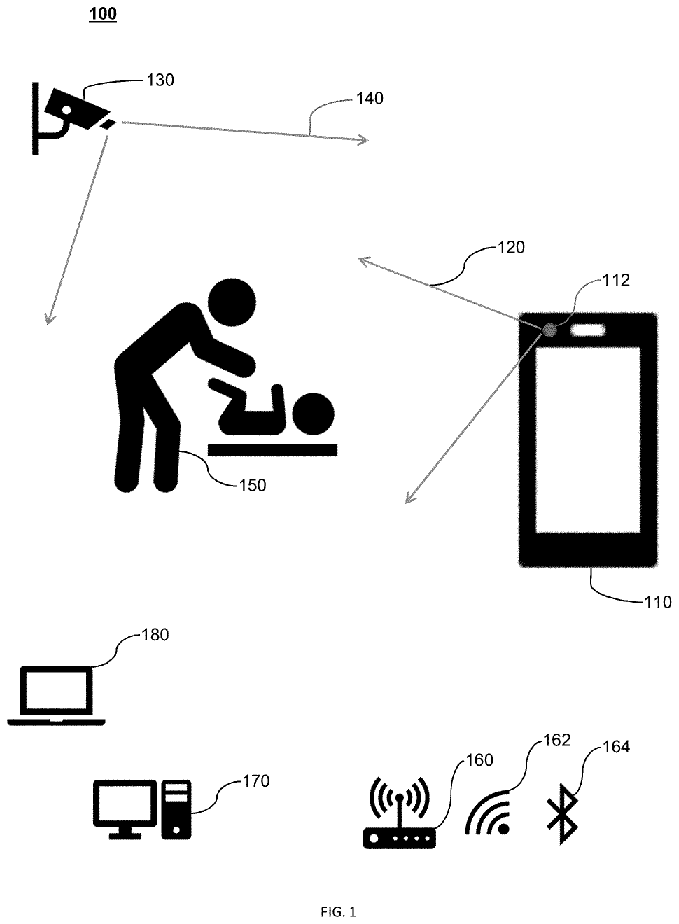

FIG. 1 shows a viewpoint of cameras capturing images or videos of people. The client 110 is a smart phone including the cameras 112. The cameras 112 may support many types of lens such as telephoto, wide, ultra-wide, depth and other specific feature lens. The view angle lines 120 of the cameras 112 may be determined by what kind of lens the client 110 uses. The lens of the client 110 may determine the view angle lines 120. The client 130 is a surveillance camera which supports a networking function, such as CCTV (Closed-Circuit Television) camera, IP (Internet Protocol) camera, IP dome camera and other cameras. The view angle lines 140 of the client 130 may depend on what kind of lens it uses.

The client 110 and 130 may be capturing the images of the users 150 and transmit to the computing unit of the client 110, 170, 180, local or remote servers or super computers for identifying their behavior. The client 170 and 180 are personal computer and laptop, they may be including cameras which are also in charge of capturing the images of the users 150. Basically, the client 110, 130, 170 and 180 may include any kind of communication unit supporting protocols 162 or 164, such as 5G (5 Generation) or 4G, Wi-Fi, Bluetooth and other networking technologies. The client 160 may be a broad band device like router or other devices supporting 5G or 4G, Wi-Fi, fiber, Ethernet and other networking technologies. It may connect with the client 110, 130, 170 and 180 by using Wi-Fi or Ethernet networking technologies.

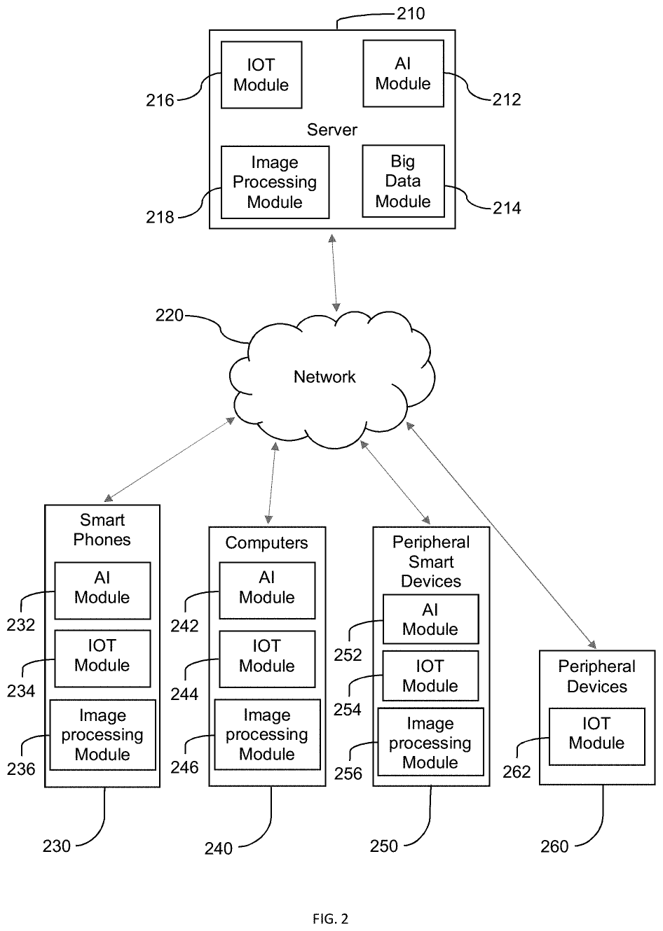

FIG. 2 is a block diagram of a system that may be used to implement the methods and systems described in the document. The system described herein includes server 210, network 220, smartphones 230, computers 240, peripheral smart devices 250 and peripheral devices 260. The server 210 may consist of multiple servers and connect with multiple clients via the network 220. In one example, other such entities may also exist in the system and be connected to the network 220. The server 210 may be located at local area or remote site and communicate with the multiple clients via the network 220. It may implement methods by using one or more servers and a cloud platform. The server 210 may provide schedule setting services, alarms services, chat services, video services, image services and other services. It includes AI module 212, big data module 214, IOT module 216 and image processing module 218.

The functionality of the AI module 212, IOT module 216 and image processing module 218 may be more sophisticated than the one of all clients' modules. So, all clients may be in charge of simple functionality, and transfer a plenty of data to the server 210 for computations and storage. The functionality of the AI module 212 may include automatic schedule setting, process's improvement of existing schedule, automatic searching information, human behavior recognition, human negotiation, teaching & educating and other friendly functions. The functionality of the big data module 214 may include behavior's collection, speech's collection, knowledge's collection and other information collection. The functionality of the IOT module 216 may include automatic registration and release of clients, automatic communication session setting, information collection, alarms activating and other functions. The functionality of the image processing module 218 may include images or videos capture, image recognition, images or videos loss recovery, cameras control request and other functions.

The network 220 may be implemented by using standard protocols of communication such as Dynamic Host Configuration Protocol (DHCP), File Transfer Protocol (FTP), Hyper Text Transfer Protocol (HTTP), Internet Message Access Protocol (IMAP), Network News Transport Protocol (NNTP), Network Time Protocol (NTP), Post Office Protocol-Version 3 (POP3), Simple Mail Transfer Protocol (SMTP), Simple Network Management Protocol (SNMP), Multi-Protocol Label Switching (MPLS) and Transmission Control Protocol/Internet Protocol (TCP/IP). In one implementation, the 5th generation mobile networks (5G) may be one of suitable communication technologies. High bit-rate and low network-latency of the 5G network may make images and videos transferred smoothly between clients and servers.

The smart phones 230 is a computing device, which may include AI module 232, IOT module 234 and image processing module 236. Basically, the computing power of smart phone is less than one of the server 210. So, the AI module 232, IOT module 234 and Image Processing module 236 of smart phones 230 may be reduced models of the server 210's modules. They may execute a part of functions of the server 210's modules and transfer a plenty of data to local or remote servers via network 220 for computations.

Generally, the smart phones 230 is a popular device for users to implement the method. They may make a request to the smart phones 230 for starting the system. The system may establish a communication session between the smart phones 230, local and remote server and other clients, and then make configuration for all the devices. The other clients mentioned herein include computers 240, peripheral smart devices 250 and peripheral devices 260. It may monitor users by using cameras, microphones, sensors and other components or modules of the smart phones 230, computers 240, peripheral smart devices 250 and client 130. These clients may be configured to capture voice signals and images or videos of the users. When they are behaving for schedule's settings, the system may control the cameras of these clients to capture their voice signals and images or videos and transfer to servers for computations in order to create new schedules. After the new schedules are established, it may begin to execute the new schedules to monitor user's behavior by using the cameras of these clients.

In relation to setting a new schedule, the system may analyze the first frame or more frames of the images or videos to figure out a new or existing behavior or activity. When the new behavior or activity happens, it may continuously collect and analyze the data of user's behavior until the new schedule setting finishes. Then it may transfer the data of the user's behavior to the big data module 214 for classification and storage. The AI module 212 may collect all the data of user's behavior to set the new schedule. Otherwise, it may stop doing the collection and remove all the data which is confirmed to belong to the existing schedules. In one implementation, the method may support two models to set the new schedule. One is that the decision of the schedule settings is controlled by the system. The other is that the decision of the schedule settings is controlled by users. Users may be able to control the smart phones 230 for executing the schedule settings by using some ways such as speech, gesture and other controlling ways. For example, users may give the smart phones 230 a speech command for starting the schedule settings. The smart phones 230 may identify the speech command and confirm it with users. The local or remote servers 210 may simultaneously receive the command transmitted by the AI module 232. The AI module 212 may initiate the configuration to complete the schedule settings.

In one implementation, the smart phones 230 may be built in several powerful computing units capable to handle the new schedule settings instead of the local or remote servers 210. The AI module 232 may be configured to control cameras, microphones, sensors and other components or modules of other clients for collecting and analyzing voice signals, images or videos and other information of the user's behavior in order to set the new schedule. It may deliberately request the servers to send the data of the existing schedules back to the AI module 232 for confirming that the user's behavior belongs to the existing or new schedules. Basically, it may transfer the voice signals, images or videos and other information to servers for comparison, and get the result back. The AI module 232 may keep collecting and analyzing all the data of user's behavior until the new schedule setting finishes. Otherwise, it may stop doing the collection and analysis, and then remove all the data which is confirmed to belong to the existing schedules.

In response to executing the schedules which was configured before, the system may transmit a lot of data, which are extracted from the voice signals, images or videos and other information during the establishment of the new schedules, back to the AI module 232 for identification. It may request the AI module 232 to activate the IOT module 234 for initiating the peripheral smart devices 250 and peripheral devices 260 to collect data produced by users or activate alarms to users. The AI module 232 may also control the cameras, microphones, sensors and other components or modules of the smart phones 230 to collect data. It may activate the image processing module 236 to identify user's faces and behavior or transmit the data to servers for comparing with one stored in the big data module 214. The image processing module 236 may also be configured to adjust the parameters of the cameras by analyzing images or videos captured by the cameras. When users make wrongdoing, the AI module 232 may activate alarms and advise users to finish the processes of the schedule. In another implementation, the system may request the servers to control all the clients to finish the execution of schedules.

The IOT module 234 may be configured to set a communication session with computers 240, the peripheral smart devices 250 and peripheral devices 260 when the schedules is requested to set or execute by users. It may support many communication protocols over long and short distances, such as 5G&4G, Wi-Fi, Bluetooth, NFC (Near Field Communication) and other communication technologies. If the AI module 232 receive user's commands, it may initiate the IOT module 234 to set a communication session and then send the commands to the AI module 212. The IOT module 216 may transmit a list of all clients in the area where users locate to the IOT module 234. The AI module 232 may be configured to periodically collect information from other clients and then transfer to the AI module 212 for computations.

When any client registered is attending again or leaving, the IOT module 234 may refresh the list and transfer it to the IOT module 216. The AI module 232 may also be in charge of a registration of a new client. For example, users may place speech commands to the smart phones 230 for making the registration for the new client. The AI module 232 may automatically request the IOT module 234 to set the communication session with the new client in order to get the information of the new client for making the registration for users. It may simultaneously make the IOT module 234 refreshed the list of the clients and transfer the data of the registration to the AI module 212 for the registration of the new client.

The method may first request users to register their membership before they use the services. In one implementation, the AI module 232 may be configured to automatically make the registrations for users when users place speech commands. It may request the facial image of the users for facial recognition and capture the body images of the users for body's recognition after they start the services. It may also capture images of all things in the area where users locate, especially something moving. The AI module 232 may store the positions of all the things in the memory in order to remind users the position of something when users are looking for it. These data of the images may be stored in the storage of the smart phones 230 and local or remote servers 210, respectively.

The image processing module 236 may be configured to identify the faces and bodies of users and monitor all things in the area. When user's face is changed, for example new hairdo, it may inform the AI module 232 to store the images of user's face changed, and transfer these images to the local or remote servers 210. The image processing module 236 may intentionally catch and store more and more new images of users in the storage. In one implementation, an image may include a user, an animal, devices and other things. When the image is sent to the image processing module 236, it may split the image into different objects and extract a variety of different elements from them for analysis. If the element or object is not changed, it may stop analyzing this element or object, and then only concentrate on the element or object changing. If an element or object in an image is too small to analyze, the image processing module 236 may send a message to the AI module 232 for zooming the images. The AI module 232 may control camera's lens of clients to zoom in through the IOT module 234.

In one implementation, the method may support multitasking operations. When many users simultaneously do their businesses in the same area, some users may participate in the same image. The AI module 232 may split users into individual objects and deal with them at the same time respectively. If the computing power of smart phones 230 is limited, the AI module 232 may realize that it cannot afford to deal with the computations, and then determine to transfer most of computing operations to the local or remote servers 210. After the computing operations finish, the AI module 212 may send the result and instructions to the AI module 232 for further operations. Otherwise, the AI module 232 may take all of the computations instead of the AI module 212 in order to save time and prevent from data loss during the communication season. In another implementation, the AI module 232 may simultaneously deal with operations of monitoring and schedule settings for different users or things participating in a same image. It may also split these users or things to different tasks and transmit these tasks to the local or remote servers 210 for further computations.

The computers 240 may be able to implement the method like the smart phones 230. The functionality of the modules 242, 244 and 246 are similar to the one of the smart phones 230's modules. The computers 240 may include cameras which can be in charge of capturing images or videos of users. So, the cameras on the smart phones 230 and computers 240 may be configured to work with each other and capture images or videos of users for the system. The peripheral smart devices 250 may be able to implement the method like the smart phones 230 and computers 240. The functionality of the modules 252, 254 and 256 are similar to the one of the smart phones 230's modules. They may include computing boards, cameras and sensors to do the same tasks like the smart phones 230 and computers 240. It can be a robot, robotic vacuum cleaner, refrigerator and other smart devices. The robot may include the powerful computing board similar to one of computers 240. It may include different modules like the modules 242, 244 and 246. It depends on the requirement.

Most of peripheral devices 260 may include a simple computing board and only include the IOT module 262. The IOT module 262 may be defined to transmit its information to other smart devices rather than control other clients. It may support many communication protocols over short distances, such as Bluetooth, NFC (Near Field Communication), ZigBee, RFID (Radio Frequency Identification) and other communication technologies. In one implementation, some stuffs in the area where users locate, not including a simple computing board, may be put in the place where cameras cannot find them. For example, they are placed in the bag. They may be attached with a tag of RFID in order to be easily found out.

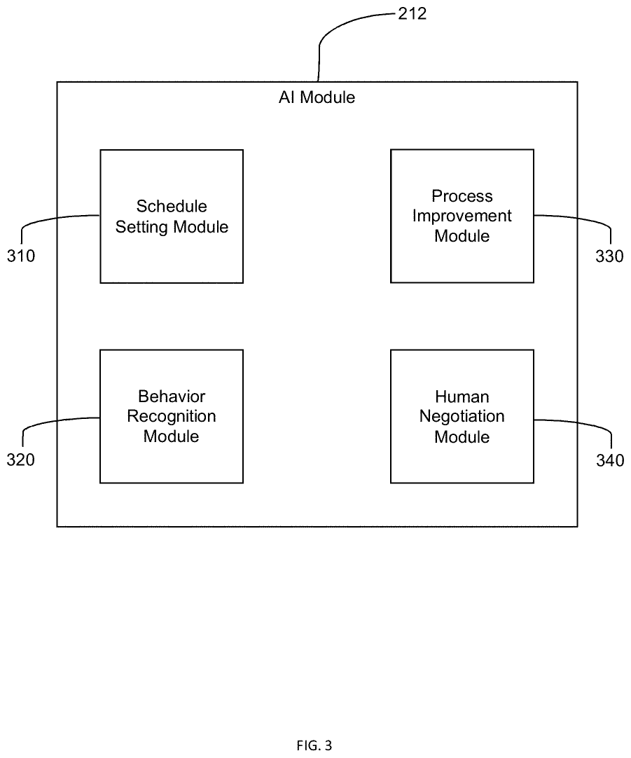

FIG. 3 is a block diagram illustrating the AI module of the server. The AI module 212 includes schedule setting module 310, behavior recognition module 320, process improvement module 330 and human negotiation module 340. The method may support two solutions of starting to set schedules. One solution is that the decision of setting schedules is controlled by users, the other one is controlled by the schedule setting module 310. If the decision of schedule's setting is controlled by users, the schedule setting module 310 may be configured to take the control of schedule's setting after users make the decision. For example, users can speak out a speech command to their clients for starting a schedule's setting. Their clients may send the command to the schedule setting module 310. The schedule setting module 310 may take over of the schedule's setting and request to initiate a communication session with all of clients and sensors in the area where users locate through the IOT module 216. It may interact with all of the clients and sensors to collect images or videos and information in order to set the schedules. In one implementation, the method may support the technology of multitasking to simultaneously process a number of users' requests from one client or multiple clients. The system may receive the requests from sensors, cameras or other functionalities of the smart clients. It may build up a lookup table to manage these sensors, cameras and other functionalities of the smart clients while they was registered.

However, if the decision is controlled by the schedule setting module 310, the schedule setting module 310 may request the IOT module 216 to set a communication session with all of the clients in the area where users and their animals locate, and keep the communication session living without release. Then it may directly control the cameras, microphones, sensors and other components or modules of the clients to capture the voice signals, images or videos and other information of user's and animal's behavior or activity. The schedule setting module 310 may be configured to simultaneously execute the monitoring and setting modes of schedules. It may take the first frame of their images and transfer to the behavior recognition module 320 for analysis. The behavior recognition module 320 may analyze their behavior or activity a frame by a frame and compare with all the data of the existing schedules in the database. It may keep analyzing the frames until the user's behavior or activity finishes. If the new user's behavior or activity happens, the schedule setting module 310 may determine to set the new schedules. Otherwise, it may stop capturing these images or videos and information and change to the monitoring mode of schedules.

The process improvement module 330 may be configured to decompose the user's behavior or activity into a lot of processes, and request the big data module 214 to periodically collect new knowledge on the internet for improving the user's behavior or activity. If new knowledge is found, the big data module 214 transfer it to the process improvement module 330 for modification. Then the process improvement module 330 may send a request to the human negotiation module 340 for informing users the solutions in order to improve the results of user's behavior or activity. If they acknowledge it, the process improvement module 330 may modify the processes in the schedules for making the results of user's behavior or activity better.

The human negotiation module 340 may include a unit which is used to negotiate with users. Users may interact with the human negotiation module 340 through clients by using some ways such as speech, gesture and others. It may request the IOT module 216 to make a communication session with all of clients and sensors in the area where users locate to collect images or videos, voice signals and other information. It may convert them to be a lot of processes or instructions for setting new schedules or further controls. The human negotiation module 340 may be configured to instruct users to do something during execution of schedules or discuss with them about the scenarios of the new schedules for modifications.

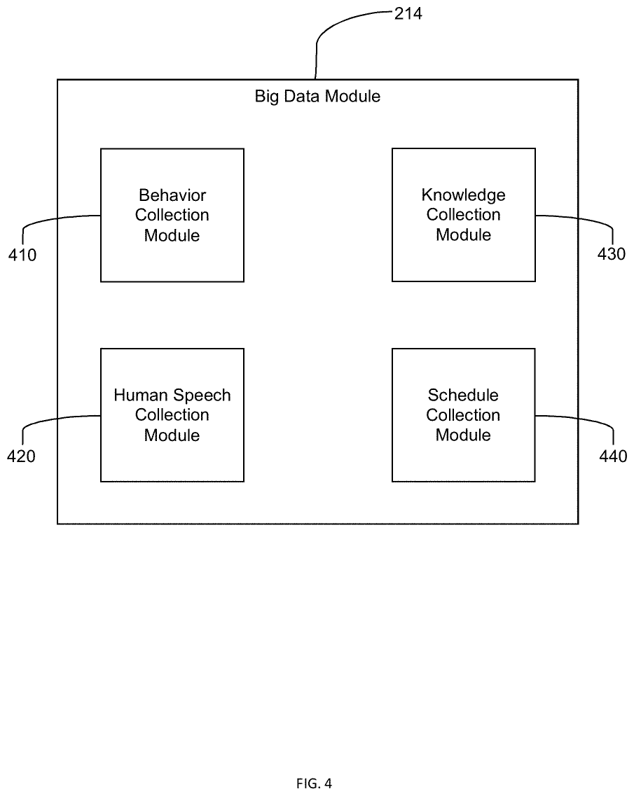

FIG. 4 is a block diagram illustrating the big data module of the server. The Big Data module 214 includes behavior collection module 410, human speech collection module 420, knowledge collection module 430 and schedule collection module 440. The behavior collection module 410 may be configured to collect and classify images and information of user's behavior, and keep them in the storage. When the image processing module 218 receives images of user's behavior, it may split the images of the user into a lot of objects and extract many elements from these objects. These elements may be intended to compare with the ones of the existing behavior in a database. It may continuously check whether the objects exist or not until the user's behavior finishes and keep the in the memory. If this object is a new one, the image processing module 218 may notice the behavior collection module 410. The behavior collection module 410 may make a record in a list of user's behavior to show that this user's behavior is the new one. Otherwise, it may remove all the data from the memory.

The human speech collection module 420 may be configured to collect user's spoken contents and manage them in a list. In one implementation, the system may receive the spoken contents through microphones of clients in the area where users locate and extract a lot of elements from them in order to compare with the data of the spoken contents kept in a storage. Then it may realize what users talk, and reply to them or implement their request. Before running the function, the human speech collection module 420 may be intended to identify a character of a user by analyzing their voice. If their voice is changed, it may check their identification by identifying their face captured by cameras or requesting their oral password. Basically, the human negotiation module 340 is configured to get the data of the user's speech, it may classify the contents and convert them to a lot of elements. It may determine to check whether the contents are existing in the storage or not. If they are similar, the contents may be removed. Otherwise, the contents may be kept in the storage and sent to the human speech collection module 420 for arranging in the list.

The knowledge collection module 430 may be configured to collect knowledges for improving the results of user's behavior or activity. It may periodically search for information, which is used to modify the processes of schedules, on the internet or receive one from service providers. In one implementation, the knowledge collection module 430 is configured to get the information, it may transmit it to the process improvement module 330 in order to rearrange the processes of the existing schedules to be new processes. The process improvement module 330 may deliberately simulate the new processes to get a new result. If the new result is better than the one of the existing processes, it may inform users about it and demonstrate the new processes for them. Additionally, the new schedules may be established after users acknowledge it. The knowledge may be classified to form a list and stored in the storage.

The schedule collection module 440 may be configured to collect all schedules and arrange them in a list. Actually, schedules consist of a lot of behavior or activities, different arrangements of the behavior or activities may create new schedules. When the schedule setting module 310 determines to creates new schedules, the system may request the behavior recognition module 320 to check all scenarios of user's behavior or activity in the schedules. If the new schedules are similar to existing one in the database, it may remove all the data of the new schedules and inform users about it. Otherwise, the new schedules may be established and stored in the database. The schedules collection module 440 may be intended to refresh the list of the schedules. Additionally, a user can modify some scenarios in the schedules, the schedule setting module 310 may be requested to execute the modifications to create new schedules instead of original schedules and then refresh the list.

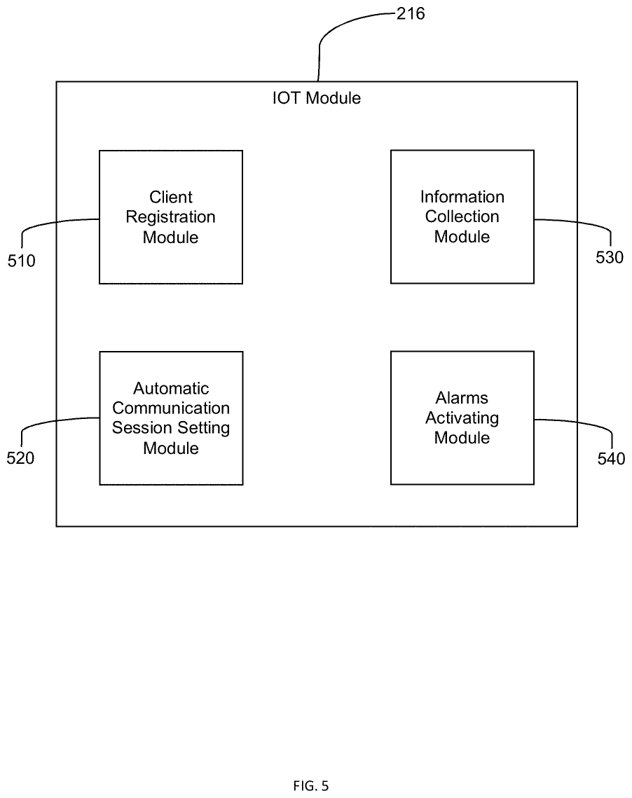

FIG. 5 is a block diagram illustrating the IOT module of the server. The IOT module 216 includes client registration module 510, automatic communication session setting module 520, information collection module 530 and alarms activating module 540. The client registration module 510 may be configured to manage all clients in an area where users locate and establish lists for them. The lists mentioned herein may include membership's and session's list. A new client participating in the area may be requested to provide some information with the client registration module 510 for the registration in order to join into a communication session. The client registration module 510 may automatically complete the registration and configuration for the new client. After the registration finishes, the new client may attend in the communication session and interact with other clients and servers. The membership's list may be refreshed for the new client. When the client leave from the area, it may disconnect with network and leave the communication session. The client leaving from the area may be removed from the session's list. The session's list may be refreshed too. But, the membership's list may not be changed unless the system detects that the client is damaged. If the client is damaged, the system may automatically uninstall it and inform users about it. It may request the client registration module 510 to remove it from the membership's list.

The automatic communication session setting module 520 may be configured to automatically establish a communication session for all clients in the area where users do activity. In one implementation, the system may only request the automatic communication session setting module 520 to set up the communication session with some clients, such as cameras and microphones, to monitor them due to finding they appear in the area. If it figures out that they want to proceed or establish the schedules, the system may request the automatic communication session setting module 520 to set up the communication session with all clients in the area. When users complete it, the system may determine to temporarily terminate the communication session in order to save power consumption, even make all clients kept in the sleep mode. Additionally, the automatic communication session setting module 520 finds that a client disconnects with the network 220, it may try to connect with the client again if it still stay in the area. Otherwise, it may inform the system to fresh the session's list. When a client appears over the network 220 again, the system may first confirm its membership. If it is a registered client, the automatic communication session setting module 520 may set up the communication session with the client.

The information collection module 530 may be configured to periodically collect information from all clients participating a communication session. It may deliberately interact with the clients to get the data of calculations, estimation and their status such as power consumption, operating mode, energy stage and other information. When a schedule's setting happens, the system may request the information collection module 530 to collect information from all clients participating a communication session in order to establish the new schedules. When users participating in the area are found by cameras, the system may simultaneously initiate the schedules and monitor their behavior or activity. It may establish a communication session with all clients in the area and request the information collection module 530 to collect information in order to check whether the user does right things. In one implementation, if a new schedule's setting is controlled by the system and their behavior or activity is different from one existing in the database, the system may collect all the data until their behavior or activity finishes in order to establish the new schedule.

The alarms activating module 540 may be configured to activate alarms to users who make wrongdoing. When the user does activity, the system may deliberately initiate schedule's programs to monitor them and request the information collection module 530 to collect information from all clients participating a communication session in order to check what the user does. For example, the user neglect doing something in the schedules, the system may find out it by analyzing the images or status that the information collection module 530 doesn't receive information from some clients attending the communication session. It may request the alarms activating module 540 to send commands to the clients for activating alarms to the user in order to remind them to do the things in the schedules.

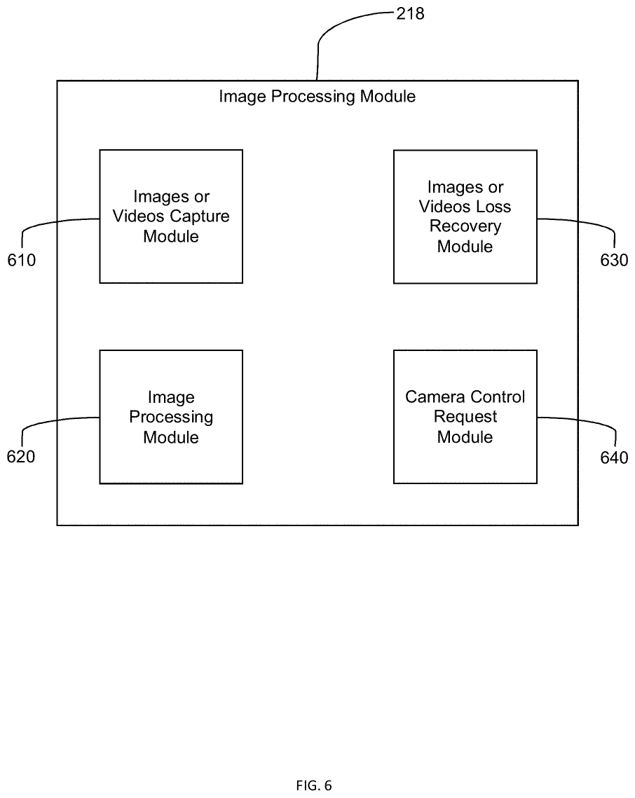

FIG. 6 is a block diagram illustrating the image processing module of the server. The image processing module 218 includes images or videos capture module 610, image processing module 620, images or videos loss recovery module 630 and camera control request module 640. The images or videos capture module 610 may be configured to control cameras of clients to capture images or videos of users doing something. It may directly take a control of the cameras or send a request to clients for completing tasks. When users run into the territory which the system monitors, the system may request the images or videos capture module 610 to capture the images or videos of users through the cameras of the clients. It may simultaneously initiate the schedule's program. For example, the images or videos capture module 610 sends a request to the client 110 to capture images or videos by using the cameras 112, and directly control the client 130 including a networking module to capture the images or videos.

The image processing module 620 may be configured to make a lot of processing operations of images transferred from the images or videos capture module 610. The images or videos capture module 610 may transmit videos to the image processing module 620, the image processing module 620 may convert the videos into a lot of frames and further split the frames to many objects. These objects may deliberately be arranged to extract a lot of elements for analysis and comparison with the ones in the database. In one implementation, the image processing module 620 may classify these objects and elements to several categories for their characters and transfer them to the big data module 214 for arranging and storing in the storage. When users or system requests to establish a new schedule or schedules are requested to run, the image processing module 620 may be requested to proceed images, videos or information captured by clients. It may analyze them and dig out their characters, and transfer these characters to the big data module 214 in order to search for similar objects and elements for comparison. If the big data module 214 finds the same or similar objects and elements, it may transmit them back to the image processing module 620 for comparison.

With respect to transmission and storage, the image processing module 620 is configured to adopt the technologies of the compression and decompression. The compression can downsize an amount of data of images, videos or information, it's good for the transmission and storage. However, it is requested to analyze the user's behavior or activity or receive the data over the network 220, it may have to adopt the technology of the decompression for retrieving the data. Additionally, users may install a lot of the client 130 built in a networking module such as PTZ (Pan Tilt Zoom) camera in the area where users locate. However, the images or videos captured from the client 130 may be unclear or lost, the image processing module 620 may request the client 130 to control its lens and make the images or videos clear or capture these images or videos again. Moreover, it may request the camera control request module 640 to determine which of cameras operate to capture the images or videos, and then arrange and combine these images or videos for analysis. It may also choose one camera to capture images or videos in order to prevent from complex operations of combination of images or videos.

The images or videos loss recovery module 630 may be configured to recover images or videos lost. The images or videos capture module 610 is requested to take a control of cameras of clients to capture images or videos of users doing something in response to setting or executing schedules. These clients in the area where users stay may transmit the images or videos to the images or videos capture module 610 via the network 220. However, the network 220 is complicated and sometimes crowded, the data loss of the images or videos transmitted over the network 220 may often happen. The images or videos capture module 610 may transfer the images or videos to the images or videos loss recovery module 630 for checking the data loss. When the data loss happens, the images or videos loss recovery module 630 may record the images or frames and request the clients to transmit the images or frames again, and then combine them with original images or videos to form new images or videos.

The camera control request module 640 may be configured to control cameras of clients in the area where users locate. In one implementation, it may support a lookup table containing a set of parameters of cameras in order to control cameras. The parameters of the lookup table may be intended to synchronize with the ones of cameras. For example, the images or videos capture module 610 can't find out users for capturing their images or videos when they decide to set new schedules or execute schedules, it may request the camera control request module 640 to control cameras. The camera control request module 640 may control the cameras through the lookup table. It may first make cameras rotated or tilted to search for users and change optical zoom to make images clear. It may determine which of cameras capture the images or videos or designate the cameras to look at respective users or one user.

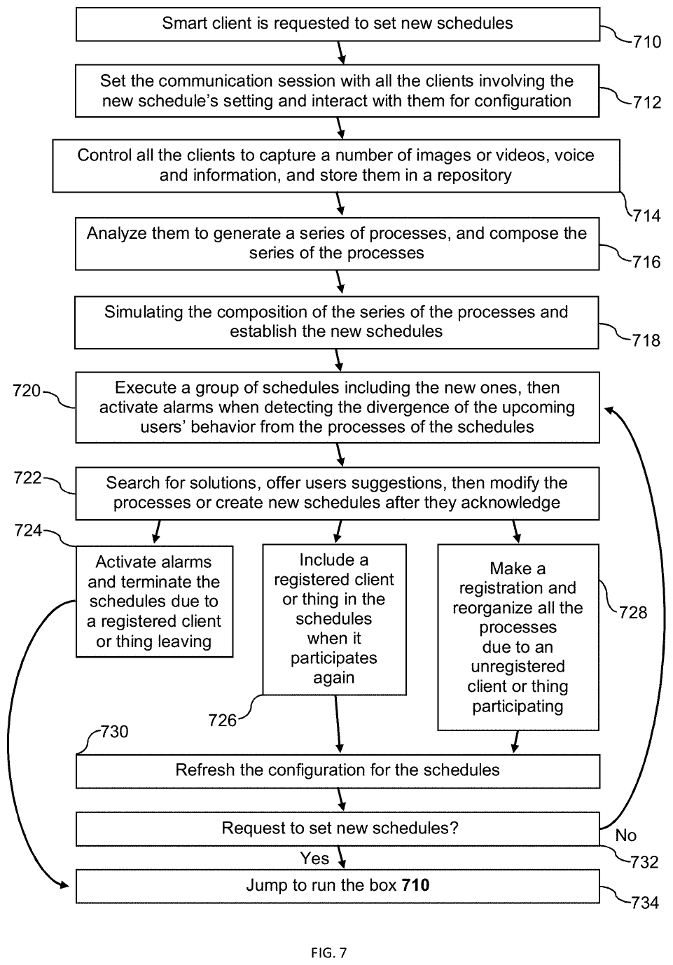

FIG. 7 is a flowchart of a process for schedules settings method. At box 710, smart client is requested to set new schedules. The box 710 represents that a user requests a smart client sending a request to the system for setting new schedules. The smart client described herein are computing devices including powerful CPU processors and OS (Operating system) such as smartphones, PC, laptop and other computing devices. Users may place commands, such as oral, manual, posture and other specific commands, to control these clients to create a request of new schedule's setting. In response to determining to set new schedules, the smart client may deliberately attempt to set a communication session with servers and transmit the request to the system. In response to receiving a request from the smart client, it may initiate the smart client built in cameras to capture images or videos In order to search for the user.

At box 712, set the communication session with all the clients involving the new schedule's setting and interact with them for configuration. The box 712 indicates that the system, which receives the requests from the smart clients engaged in a communication session over the network 220, determines to establish the communication session with all the clients participating in the network 220 and involving the new schedule's setting. After the communication session is ready, the system may interact with all the clients engaged in the communication session over the network 220 for configuration. In one implementation, the system may apply a lookup table to manage all the clients and their sensors, cameras and other functionalities during the interaction. Then, it may have to configure all the clients in order to set new schedules.

The system may record the technologies of communication used in the interaction between clients and servers in a lookup table. For example, smartphones and servers include modules of 5G and WIFI, the default of smartphone's communication is configured to use the 5G communication, and the WIFI communication is a backup solution. During the interaction between the smartphones and servers, the servers may determine to initiate the WIFI communication of the smartphone for transmission in response to detecting that the 5G communication of the smartphone is gradually becoming slow and unstable. In one implementation, the system may only establish the communication session with clients in the area where users locate for the configuration. So, it may not set the communication session with clients locate out of the area in order to reduce power consumption and networking traffic.

At box 714, control all the clients to capture a number of images or videos, voice and information, and store them in a repository. The box 714 indicates that the system may apply the lookup table to manage all the clients in the area where the users locate in order to capture a number of images or videos, voice and information for setting new schedules, and store the number of images or videos, voice and information in the respective repositories. It may determine how many clients including cameras and microphones are intended to capture the number of images or videos and voice. It depends on the requirement and is configured by a software designer. The system may have to figure out that a user finishes their behavior or activity and confirm it with a user, and then stop capturing the images or videos and voice. With respect to the repositories, the system may be intended to store the number of images or videos, voice and information in the repositories of smart clients, local and remote servers.

At box 716, analyze them to generate a series of processes and compose the series of the processes. The box 716 represents that the system is requested to analyze the number of the images or video streams, voice and information to generate a series of processes and compose the series of the processes. The information described herein is data outputted from sensors, components or specific electronic or mechanical module built in the clients or other things. In one implementation, the system may extract different frames, objects and elements from the number of the images or videos, voice and information for analysis. It may remain these frames, objects and elements in a number of queues in a particular order for waiting to be processed, and then generate the series of processes. Moreover, it may be intended to compose the series of the processes for the new schedules, and create a lookup table to manage their sequence.

At box 718, simulating the composition of the series of the processes and establish the new schedules. The box 718 represents that the system is requested to simulate the composition of the series of the processes, and then establish the new schedules. In relation to verifying the functionalities of all the clients, the system may reorganize all the processes and connect them together in a configured sequence in order to simulate all the operations of the new schedules. It may simulate these operations to inspect whether the functionalities of all the clients work or not. If the functionalities work, the system may indicate that the new schedules are established and send information to clients in order to inform users about that the new schedules are ready to be used. The system may be intended to integrate the new schedules with a number of existing schedules after the configuration for all the clients finishes. It may be configured to monitor the user's behavior or activity by executing the number of the schedules.

At box 720, execute a group of schedules including the new ones, then activate alarms when detecting the divergence of the upcoming users' behavior from the processes of the schedules. The box 720 indicates that the system may execute a group of schedules including the new ones to monitor the number of the images or videos, voice and information, then activate alarms when detecting the divergence of the upcoming users' behavior from the processes of a group of schedules. The system may initiate the group of the schedules including the new ones to monitor users' behavior or activity in order to detect the divergence. The divergence of the behavior or activity describes herein includes skipping a part of the processes, a wrongdoing during the processes, missing the timing and other factors. When the divergence happens, the system may be intended to send instructions to the clients nearby users for alarming them or demonstrate how to correct the mistakes. The alarm can probably be implemented in many ways such as speech, vibration, sounds and lights. Moreover, the system may be configured to operate the multitasking mode for executing the operations of the box 720 and 722 at the same time. With respect to sharing the computing resources of the system, it depends on the definition of the system.

At box 722, search for solutions, offer users suggestions, then modify the processes or create new schedules after they acknowledge. The box 722 indicates that the system periodically search for solutions and offer users suggestions after finding out them. Then it modify the processes of the existing schedules or create new schedules after they acknowledge. Basically, the existing schedules may be established based on the user's requirement or the definition of an app designer. They may not be good, useful and efficient anymore in the future. The system may be configured to search for new solutions on the internet for improving the processes of the existing schedules or creating new schedules. The new solutions mentioned herein may be new objects, processes or knowledge. When finding out the new solutions, the system may provide users with suggestions for the modification or creation of the new schedules. In response to their acknowledgement, it may be intended to adopt the new solutions into the processes of the existing schedules or creating the new schedules, then reorganize the processes to create or directly generate a prototype for the simulation of the new schedules. It may simulate the prototype to verify the functionalities of hardware, firmware and software. If the verification of the functionalities finishes, it may demonstrate the new schedules by itself to check whether the new processes are correct and smooth. After the demonstration, the new schedules may be confirmed and established to replace the existing ones. Then they may be included into a group of schedules.

At box 724, activate alarms and terminate the schedules due to a registered client or thing leaving. The box 724 indicates that the system detects a registered client or thing leaving the communication session or area where users locate, then activate alarms through clients in the area where users locate and terminate the schedules which a client or thing involves. Basically, this procedure includes an operation of an interruption. The system may be configured to interrupt the operations of the box 722 and then jump to run the box 724 when the situation of the registered client or thing leaving is detected. Generally, the system is configured to monitor the status of all the registered clients or things in a group of schedules. With respect to the registered client or thing leaving, it may affect the result of executing the schedules. When the system detects that the registered client or thing leave the communication session or area where users locate, it may send alarms to the clients engaged in the communication session over one or more networks nearby the users, then terminate the schedules which a client or thing involves and jump to run the box 732.

At box 726, include a registered client or thing in the schedules when it participates again. The box 726 represents that the system is requested to include a registered client or thing in the schedules when the client or thing participates in one or more networks or the area where users locate again. Basically, this procedure includes an operation of an interruption. The system may be configured to interrupt the operations of the box 722 and then jump to run the box 726 when the situation of the registered client or thing participating again is detected. In one implementation, the registered client or thing leaves the communication session over one or more networks or the area where users locate, the system may determine to terminate the schedules involved. When the registered client or thing participates in one or more networks or the area where users locate again, the system may be requested to include the registered client or thing into the schedules. Then, the schedules may be activated again after the configuration is refreshed.

At box 728, make a registration and reorganize all the processes due to an unregistered client or thing participating. The box 728 represents that the system is requested by users to make a registration for the unregistered client or thing and reorganize all the processes due to the unregistered client or thing participating in the communication session over one or more networks or the area where users locate. Basically, this procedure includes an operation of an interruption. The system may be configured to interrupt the operations of the box 722 and then jump to run the box 728 when the situation of the unregistered client or thing participating is detected. The unregistered client or thing mentioned herein is a new one which has not appeared in the schedules, and the thing doesn't include a computing unit. With respect to the registration of the client or thing, they may be put in the place where the system is easy to connect to and monitor them. The system may is configured to first establish a communication session with the unregistered client, then it may capture the appearance's image of them to complete the registration.

At box 730, refresh the configuration of the schedules. The box 730 indicates that the system is configured to refresh the configuration of the schedules that are involved by a client or thing whose status was changed. Regarding the status of the client or thing being changed, it may happen when the unregistered client or thing participates or the registered client or thing in the schedules participates again. Concerning the registered client or thing participating in the existing schedules again, it may only refresh the configuration. With respect to the unregistered client or thing, the system may reorganize the processes of the schedules involve this client or thing and refresh the configuration, then make the simulation for the new schedules. When these procedures are completed, it may make a demonstration of the new schedules for internal verification or users in order to get a confirmation from them.

At box 732, request to set new schedules. The box 732 represents that the system is configured to check whether a request to set new schedules happens. The request mentioned herein is submitted from user's clients. When the request is detected, the system may jump to run the box 734. Otherwise, it may jump to run the box 720.

At box 734, jump to run the box 710. The box 734 represents that the system may be requested to jump to run the box 710 after acknowledging the request to set new schedules.

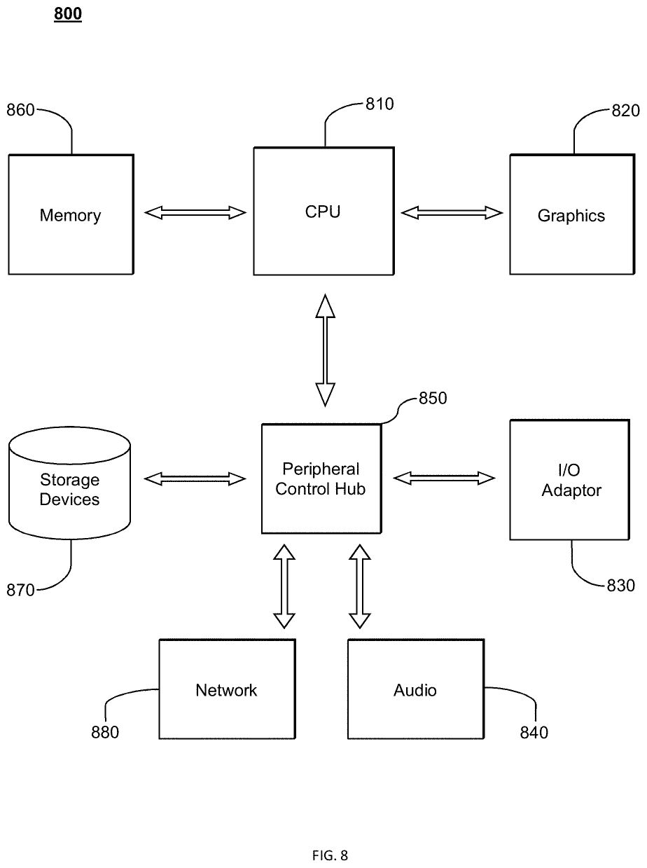

FIG. 8 is a block diagram illustrating components of a computing device that may be used to implement the methods and systems described in the document, as either a client or server. The computing system 800 represents various kinds of computing devices such as desktop, notebook, workstation, server, mainframe, and other similar computing devices. The computing system 800 described herein may be represented as the server 210, the client 240 and 250. The computing system 800 includes CPU (Central Processing Unit) 810, graphics 820, I/O devices (Input/Output) 830, an audio 840, a peripheral control hub 850, memories 860, storage devices 870 and a network 880.

In one implementation, the CPU 810 may consist of multiple CPU chips and interconnect together by using dedicated high-speed interfaces. Each CPU chip has specific high-speed interfaces connecting to graphics 820 and memories 860. The CPU 810 may include a memory controller to interact with the memories 860. The memories 860 may consist of multiple DRAM (Dynamic Random Access Memory) chips and/or modules such as DDR4 SDRAM (Double-Data-Rate Fourth Generation Synchronous Dynamic Random Access Memory) chip and other DRAM chip. In another implementation, the CPU 810 may build in a non-transitory computer-readable medium such as NOR Flash (NOR Gate Flash) for storing a set of instructions.

The peripheral control hub 850 is a processor to interact with a plurality of peripheral devices by using specific low-speed interfaces, and connects with I/O devices 830, audio 840, storage devices 870, network 880 and additional peripheral devices. The I/O devices 830 is input or output devices (e.g., mouse, keyboard, USB Hub or LED) used to input data to the peripheral control hub 850 or output data by using specific devices. The audio 840 may include an audio codec chip for encoding or decoding audio data streams from or to the peripheral control hub 850 and connect with various sound devices (e.g., speaker or microphone).

The storage devices 870 are non-transitory computer-readable media such as HDD (Hard Disk Drive) and/or SSD (Solid State Drive) for storing various computer programs, apps, photos, videos and other information. In one implementation, the storage devices 870 can be internally, locally or remotely connected to the peripheral control hub 850 by using internal interfaces, SAN (Storage Area Network) or NAS (Network Attached Storage) protocol. The system is intended to execute specific operations, computer programs and/or apps may be loaded from the storage devices 870 to the memories 860. The network 880 can support various technologies, such as Ethernet, Wi-Fi, fiber, and 5G, to connect with the network 220.

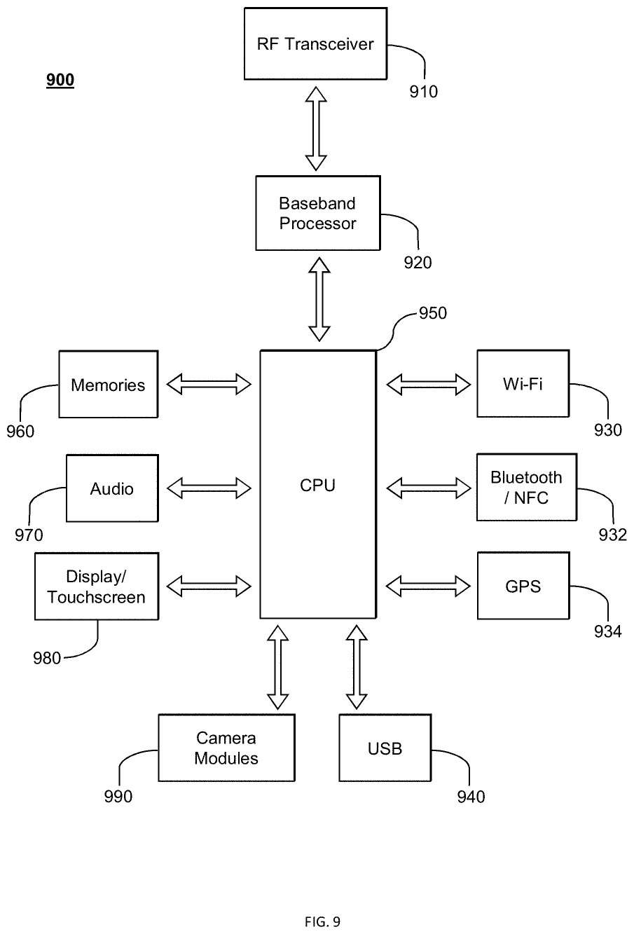

FIG. 9 is a block diagram illustrating components of a computing device that may be used to implement the methods and systems described in the document, as a client or plurality of clients. The computing system 900 represents various kinds of computing devices such as smartphone, pad, laptop, and other similar computing devices. The computing system 900 described herein may be represented as the client 230 and 260. The computing system 900 includes RF (Radio Frequency) transceiver 910, baseband processor 920, Wi-Fi 930, Bluetooth/NFC (Near-Field Communication) 932, GPS 934, USB (Universal Serial Bus) 940, CPU 950, memories 960, audio 970, display/touchscreen 980 and camera modules 990. However, the specification of the client 260 is simpler than the one of the client 230. A lot of components in the client 260 may be removed, it depends on user's demand.

In one implementation, the CPU 950 may include multiple CPU cores, memory controller and peripheral bridge, which are interconnected together by using dedicated high-speed interfaces. The memory controller may be intended to connect with memories 960 by using various buses. The peripheral bridge may be intended to connect with baseband processor 920, Wi-Fi 930, Bluetooth/NFC 932, GPS 934, USB 940, audio 970, display/touchscreen 980 and camera modules 990 by using various buses.

The RF transceiver 910 may be a component to transmit and receive RF signals through antennas and extract digital signals coupled to the baseband processor 920, which may include a signal processing unit of baseband supporting various protocols such as 3G, 4G and 5G (5th generation mobile networks). The baseband processor 920 may also be intended to process data sent from the CPU 950 and then transfer them to the RF transceiver 910 in order to transmit data to the network 220 through the antennas. The Wi-Fi 930 may be a component supporting a wireless networking technology to connect with the network 220. The Bluetooth/NFC 932 may be a component using wireless technologies to exchange data between the CPU 950 and desktop or mobile devices such as headsets, mouse, keyboard, printer, card reader and other similar devices.

The GPS 934 may be a component to receive location-based information and additional data from satellites through an antenna and transmit them to the CPU 950. The USB (Universal Serial Bus) 940 may be a component to establish a connection between the CPU 950 and external USB devices such as mouse, keyboard, printer, power charger and other similar devices. The memories 960 may be implemented as various computer-readable media such as volatile memory, non-volatile memory and expansion memory. The CPU 950 may directly connect with the volatile memory and non-volatile memory by using dedicated buses. The non-volatile memory such as NAND and NOR Flash is a non-transitory computer-readable media, and may be used for storing a set of instructions, various computer programs and apps. The system is intended to execute specific operations, computer programs and/or apps may be loaded from the non-volatile memory to the volatile memory such as SDRAM and other types of DRAM. The expansion memory is a non-transitory computer-readable media such as SSD for storing photos, videos and other information, and connect to the peripheral bridge of the CPU 950.

The audio 970 may be implemented by an audio codec and other circuits. The audio codec may be used for encoding audio digital data streams from the CPU 950 and decoding audio analog signals from a devices (e.g., microphone) converting audible sound to electrical signals. In one implementation, the audio 970 may convert the encoded audio digital data to analog audio signals and transmit them to an audible device (e.g., speakers or headsets). Moreover, the audio electrical signals may be converted to the encoded audio digital data for transmitting to the peripheral bridge of the CPU 950. The display/touchscreen 980 may be a component to drive a device of display and touchscreen. The computing system 900 may support a diversity of display technologies such as TFT (Thin-Film-Transistor Liquid Crystal Display) display, OLED (Organic Light Emitting Diode) display and other appropriate display technologies. Additionally, the computing system 900 may support various touchscreen technologies such as resistive, surface acoustic wave, capacitive and other appropriate technologies.

The camera modules 990 may be implemented by one or more camera modules. In one implementation, the computing system 900 may support at least one front-facing and rear-facing camera modules. Additionally, the resolution of the rear-facing camera may be higher than the one of the front-facing camera. The camera modules 990 may be performed various functions by executing a diversity of programs which are predetermined in the computing system 900, for example a face-recognition function. In another implementation, the at least one rear-facing camera may implement different functions by using specific lens such as telephoto lens, ultra-wide lens and other appropriate lens.

The foregoing implementations have been illustrated above, and may be implemented individually or in any combination. Additionally, various modifications can be made to the foregoing implementations.

What is claimed is:

1. A method comprising:
requesting, by a plurality of smart clients, to set a communication session over one or more networks for all clients for establishing new schedules;
interacting with all the clients engaged in the communication session over one or more networks for configuration;
controlling all the clients engaged in the communication session over one or more networks to capture a number of images or videos, voice and information;
storing the number of the images or videos, voice and information captured by all the clients in a repository;
analyzing the number of the images or videos, voice and information captured by all the clients to generate a series of processes;
composing the series of the processes, in response to the generation of the series of the processes;
simulating the composition of the series of the processes for the new schedules;
establishing the new schedules in accordance with that the simulation for the new schedules is completed and acknowledged; and
comparing the processes generated from the upcoming images or videos, voice and information captured by all the clients with those of the existing schedules in the repository, in response to the execution of the group of the existing schedules including the new ones.

2. The method of claim 1, further comprising:
searching for solutions for improving the processes of the existing schedules or creating new schedules;
providing the plurality of the smart clients engaged in the communication session over one or more networks with suggestions for modifying the processes or creating the new schedules; and
determining the modification of the existing processes or creation of the new schedules, in response to the acknowledgment of the smart clients for suggestions.

3. The method of claim 1, further comprising:
determining a registration for an unregistered client or thing, in response to the detection of the unregistered client or thing participating in one or more networks or the area where users locate; and
activating the schedules that the unregistered client or thing involves, after reorganizing the processes that the unregistered client or thing involves and refreshing the configuration.

4. The method of claim 1, further comprising:
detecting a registered client engaged in the communication session over one or more networks or thing leaving the communication session or the area where users locate;
activating alarms through the at least one client of the plurality of the clients engaged in the communication session over one or more networks; and
terminating the schedules that the registered client or thing involves.

5. The method of claim 1, further comprising:
determining a configuration of a registered client or thing, in response to the detection of the registered client or thing participating in one or more networks or the area where users locate; and
activating the schedules that the registered client or thing involves after reorganizing the processes of the schedules that the registered client or thing involves and refreshing the configuration.

6. The method of claim 1, further comprising:
monitoring the number of images or videos, voice and information captured by all the clients engaged in the communication session over one or more networks; and
activating alarms through the at least one client of the plurality of the clients engaged in the communication session over one or more networks, in response to the detection for a divergence of users' behavior from the processes of the schedules.

7. A non-transitory computer-readable medium storing instructions that, when executed by a processor, cause the processor to implement the method comprising:
requesting, by a plurality of smart clients, to set a communication session over one or more networks for all clients for establishing new schedules;
interacting with all the clients engaged in the communication session over one or more networks for configuration;
controlling all the clients engaged in the communication session over one or more networks to capture a number of images or videos, voice and information;
storing the number of the images or videos, voice and information captured by all the clients in a repository;
analyzing the number of the images or videos, voice and information captured by all the clients to generate a series of processes;
composing the series of the processes, in response to the generation of the series of the processes;
simulating the composition of the series of the processes for the new schedules;
establishing the new schedules in accordance with that the simulation for the new schedules is completed and acknowledged; and
comparing the processes generated from the upcoming images or videos, voice and information captured by all the clients with those of the existing schedules in the repository, in response to the execution of the group of the existing schedules including the new ones.

8. The method of claim 7, further comprising:
searching for solutions for improving the processes of the existing schedules or creating new schedules;
providing the plurality of the smart clients engaged in the communication session over one or more networks with suggestions for modifying the processes or creating the new schedules; and
determining the modification of the existing processes or creation of the new schedules, in response to the acknowledgment of the smart clients for suggestions.

9. The method of claim 7, further comprising:
determining a registration for an unregistered client or thing, in response to the detection of the unregistered client or thing participating in one or more networks or the area where users locate; and
activating the schedules that the unregistered client or thing involves, after reorganizing the processes that the unregistered client or thing involves and refreshing the configuration.

10. The method of claim 7, further comprising:
detecting a registered client engaged in the communication session over one or more networks or thing leaving the communication session or the area where users locate;
activating alarms through the at least one client of the plurality of the clients engaged in the communication session over one or more networks; and
terminating the schedules that the registered client or thing involves.

11. The method of claim 7, further comprising:
determining a configuration of a registered client or thing, in response to the detection of the registered client or thing participating in one or more networks or the area where users locate; and
activating the schedules that the registered client or thing involves after reorganizing the processes of the schedules that the registered client or thing involves and refreshing the configuration.

12. The method of claim 7, further comprising:
monitoring the number of images or videos, voice and information captured by all the clients engaged in the communication session over one or more networks; and
activating alarms through the at least one client of the plurality of the clients engaged in the communication session over one or more networks, in response to the detection for a divergence of users' behavior from the processes of the schedules.

13. A system comprising:
one or more processors; and
one or more non-transitory computer-readable media storing instructions that, when executed by the one or more processors, cause the system to perform operations comprising:
requesting, by a plurality of smart clients, to set a communication session over one or more networks for all clients for establishing new schedules;
interacting with all the clients engaged in the communication session over one or more networks for configuration;
controlling all the clients engaged in the communication session over one or more networks to capture a number of images or videos, voice and information;
storing the number of the images or videos, voice and information captured by all the clients in a repository;
analyzing the number of the images or videos, voice and information captured by all the clients to generate a series of processes;
composing the series of the processes, in response to the generation of the series of the processes;
simulating the composition of the series of the processes for the new schedules;
establishing the new schedules in accordance with that the simulation for the new schedules is completed and acknowledged; and
comparing the processes generated from the upcoming images or videos, voice and information captured by all the clients with those of the existing schedules in the repository, in response to the execution of the group of the existing schedules including the new ones.

14. The method of claim 13, further comprising:
searching for solutions for improving the processes of the existing schedules or creating new schedules;
providing the plurality of the smart clients engaged in the communication session over one or more networks with suggestions for modifying the processes or creating the new schedules; and
determining the modification of the existing processes or creation of the new schedules, in response to the acknowledgment of the smart clients for suggestions.

15. The method of claim 13, further comprising:
determining a registration for an unregistered client or thing, in response to the detection of the unregistered client or thing participating in one or more networks or the area where users locate; and
activating the schedules that the unregistered client or thing involves, after reorganizing the processes that the unregistered client or thing involves and refreshing the configuration.

16. The method of claim 13, further comprising:
detecting a registered client engaged in the communication session over one or more networks or thing leaving the communication session or the area where users locate;
activating alarms through the at least one client of the plurality of the clients engaged in the communication session over one or more networks; and
terminating the schedules that the registered client or thing involves.

17. The method of claim 13, further comprising:
determining a configuration of a registered client or thing, in response to the detection of the registered client or thing participating in one or more networks or the area where users locate; and
activating the schedules that the registered client or thing involves after reorganizing the processes of the schedules that the registered client or thing involves and refreshing the configuration.

18. The method of claim 13, further comprising:
monitoring the number of images or videos, voice and information captured by all the clients engaged in the communication session over one or more networks; and
activating alarms through the at least one client of the plurality of the clients engaged in the communication session over one or more networks, in response to the detection for a divergence of users' behavior from the processes of the schedules.
